(19) United States
(12) Patent Application Publication
(10) Pub. No.: US 2021/0089738 A1
(43) Pub. Date: Mar. 25, 2021

(54) Image Tag Generation Method, Server, and Terminal Device

(71) Applicant: BOE TECHNOLOGY GROUP CO., LTD., Beijing (CN)

(72) Inventors: Tingting Wang, Beijing (CN); Yue Li, Beijing (CN)

(21) Appl. No.: 16/910,146

(22) Filed: Jun. 24, 2020

(30) Foreign Application Priority Data
Sep. 25, 2019 (CN) 201910911763.4

(51) Int. Cl. G06K 7/14; G06K 9/46

(52) U.S. Cl. CPC G06K 7/1443; G06K 9/46

(57) ABSTRACT

The embodiments of the present disclosure disclose an image tag generation method, a sever and a terminal device. An image tag generation method applied to a first device, includes: receiving a tag request sent by a second device; acquiring a thumbnail corresponding to the tag request; obtaining image tags by identifying the thumbnail; and sending the image tags to the second device.

### CROSS-REFERENCE TO RELATED APPLICATION

This application claims priority to the Chinese Patent Application No. 201910911763.4 filed on Sep. 25, 2019, the disclosure of which is hereby incorporated by reference in its entirety.

### TECHNICAL FIELD

The present disclosure relates to an image tag generation method, a server, and a terminal device.

### BACKGROUND

In some social scenes or some content sharing scenes, it is often needed to tag images to label their categories, subjects, or the like. For example, the categories may include a travel photograph, a life photograph, a certificate photograph, etc., and the subjects may include a landscape, a person, etc.

In some related schemes, the category, subject, or the like of the image is usually identified manually by the user, that is, the generation of image tags depends on human experiences.

### SUMMARY

Embodiments of the present disclosure provide an image tag generation method applied to a first device, comprising:

receiving a tag request sent by a second device;

acquiring a thumbnail corresponding to the tag request;

obtaining image tags by identifying the thumbnail; and

sending the image tags to the second device.

The embodiments of the present disclosure further provide an image tag generation method applied to a second device, comprising:

sending a tag request to a first device so that the first device acquires a thumbnail to be identified based on the tag request, and obtains image tags by identifying the thumbnail; and

receiving the image tags returned by the first device.

The embodiments of the present disclosure still further provide an image tag generation method applied to a terminal device, comprising:

displaying an image uploading interface;

acquiring an image uploaded in the interface by a user;

generating a thumbnail of the image, and sending the thumbnail, an image identification, and a tag generation instruction to a server; and

receiving image tags fed back by the server, and displaying the image tags in the interface.

The embodiments of the present disclosure still further provide a server comprising a memory, a processor, and a computer program stored on the memory and executable on the processor, the processor, when executing the program, implementing the image tag generation method applied to the first device or implementing the image tag generation method applied to the second device.

The embodiments of the present disclosure still further provide a terminal device comprising a memory, a processor, and a computer program stored on the memory and executable on the processor, the processor, when executing the program, implementing the image tag generation method applied to the terminal device.

### BRIEF DESCRIPTION OF THE DRAWINGS

To describe the technical solutions in the embodiments of the present disclosure or the prior art more clearly, the accompanying drawings used in the description of the embodiments or the prior art are briefly introduced in the following. Evidently, the accompanying drawings are only some embodiments of the present disclosure, and persons of ordinary skill in the art may also obtain other drawings according to these accompanying drawings without creative efforts.

FIG. 1 is a schematic diagram illustrating a first interactive scenario provided by an embodiment of the present disclosure;

FIG. 2 is a schematic diagram illustrating a second interactive scenario provided by an embodiment of the present disclosure;

FIG. 3 is a schematic diagram illustrating a third interactive scenario provided by an embodiment of the present disclosure;

FIG. 4 is a schematic flowchart illustrating an image tag generation method applied to a first device provided by an embodiment of the present disclosure;

FIG. 5 is a schematic flowchart illustrating an image tag generation method applied to a second device provided by an embodiment of the present disclosure;

FIG. 6 is a schematic flowchart illustrating an image tag generation method applied to a terminal device provided by an embodiment of the present disclosure;

FIG. 7 is a schematic diagram illustrating a terminal device interface provided by an embodiment of the present disclosure;

FIG. 8 is a schematic diagram illustrating a structure of a server provided by an embodiment of the present disclosure; and

FIG. 9 is a schematic diagram illustrating a structure of a terminal device provided by an embodiment of the present disclosure.

### DETAILED DESCRIPTION

In order to make the objectives, technical solutions, and advantages of the present disclosure clearer and more comprehensible, the present disclosure is further described in detail in the following with reference to the accompanying drawings in combination with the embodiments.

It should be noted that all expressions using “first” and “second” in the embodiments of the present disclosure are used for distinguishing two different entities or parameters with the same name, so “first” and “second” are used only for the convenience of expression and should not be construed as limitations to the embodiments of the present disclosure, which is not explained again in the following embodiments.

The “thumbnail” mentioned in the embodiments of the present disclosure refers to an image with a reduced data amount obtained by performing a compression process on an image.

The embodiments of the present disclosure provide an image tag generation method applied to a first device, an image tag generation method applied to a second device, an image tag generation method applied to a terminal device, a server, and the terminal device.

In one case, each of the first device and the second device may be a server. The first device may be referred to as a first server, and the second device may be referred to as a second server. The first server may be an identification server for executing an image identification algorithm, and the second server may be a service server for forwarding service data. In another case, the second device may be a terminal device instead. The terminal device may be a mobile phone, a tablet computer, or the like, and is not limited specifically.

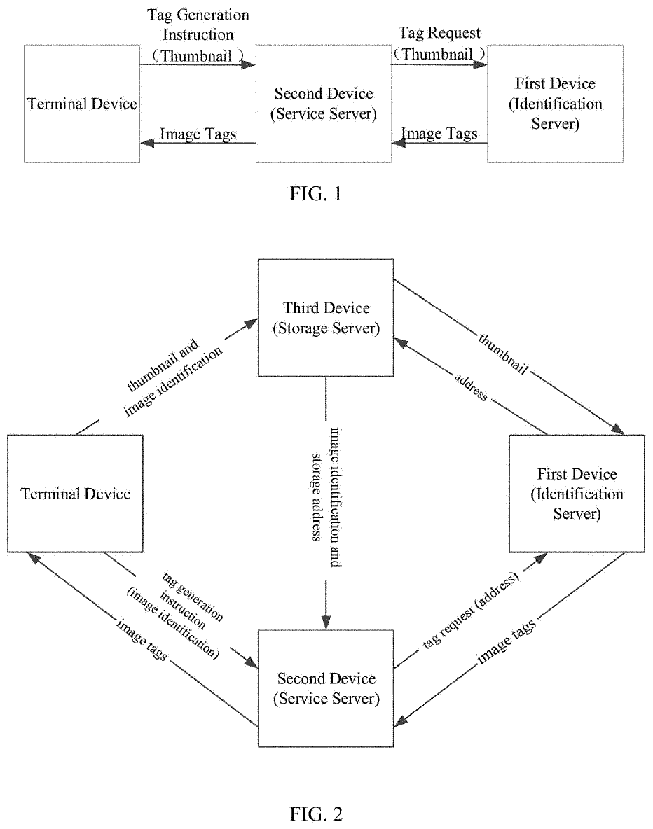

Some specific implementations are described below with reference to FIGS. 1-3, respectively.

In FIG. 1, the first device is an identification server, and the second device is a service server. The terminal device acquires an image uploaded by the user, generates a thumbnail of the image, and sends a tag generation instruction comprising the thumbnail to the service server. The service server reads the thumbnail comprised in the tag generation instruction, and sends a tag request including the thumbnail to the identification server. The identification server obtains image tags by identifying the thumbnail and sends the image tags to the service server. The service server returns the image tags to the terminal device.

Alternatively, in the embodiment of FIG. 1, the second device (the service server) may be omitted. In this case, the terminal device acquires an image uploaded by the user, generates a thumbnail of the image, and sends a tag request including the thumbnail to the identification server.

In FIG. 2, the first device is an identification server, the second device is a service server, and a third device is a storage server. The terminal device acquires an image uploaded by the user, generates a thumbnail of the image, sends the thumbnail and an image identification to the storage server. The storage server stores the thumbnail, and sends a storage address of the thumbnail and the image identification to the service server. Thus, the service server stores a correspondence relation between the address of the thumbnail and the image identification. For example, the image identification may be an image name, a serial number, and the like, which is not limited specifically.

The terminal device sends a tag generation instruction to the service server, wherein the tag generation instruction comprises the image identification. The service server searches for an storage address corresponding to the image identification as an address to be processed. The service server sends a tag generation request including the address to be processed to the identification server. The identification server acquires the thumbnail from the storage server based on the address to be processed.

The identification server obtains image tags by identifying the thumbnail and sends the image tags to the service server. The service server returns the image tags to the terminal device.

For example, the address of the thumbnail may be a URL (Uniform Resource Locator), or may be other addresses, and a specific address format is not limited.

Alternatively, in the implementation of FIG. 2, the second device (the service server) may be omitted. In this case, the terminal device acquires an image uploaded by the user, generates a thumbnail of the image, sends the thumbnail and an image identification to the storage server for storage and receives from the storage server a storage address of the thumbnail corresponding to the image identification, and sends a tag request including the storage address to the identification server. The identification server acquires the thumbnail corresponding to the tag request, obtains image tags by identifying the thumbnail, and sends the image tags to the terminal device.

In some cases, the user needs to upload an image through a terminal device such as a mobile phone or a tablet computer to share content or achieve the social purpose. In the process of uploading an image, the user often needs to add image tags, for example, a category of the image, such as a travel photograph, a life photograph, a certificate photograph, or the like, and for another example, a subject of the image, such as a landscape, a person, or the like. The image tags may indicate at least one of category, subject, and content of the image. In some related schemes, the image and its tags are uploaded generally after the user manually filling in the image tags. In this way, the user is required to manually recognize the category, subject, and the like of the image, and the user is also required to call up an input method and manually click the keyboard of the input method to enter the tags such as the category, subject, and the like of the image, which is troublesome for the user.

By applying the implementations shown in FIG. 1 or FIG. 2, the terminal device may obtain the image tags through the servers in the process of uploading the image by the user in the terminal device, so that the user does not need to manually fill in the image tags, thereby simplifying the user operation.

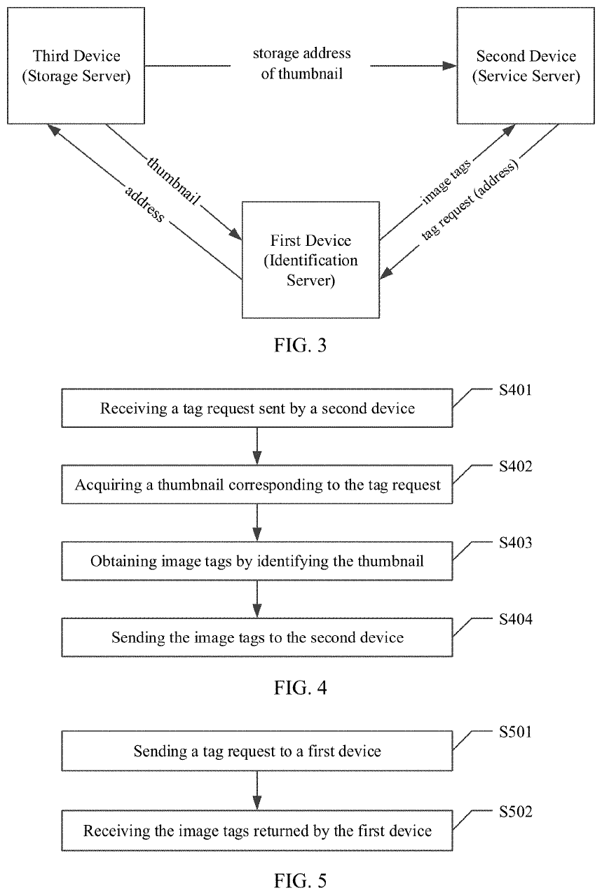

In FIG. 3, the first device is an identification server, the second device is a service server, and the third device is a storage server. The storage server can continuously store new thumbnails. The service server periodically acquires storage addresses of the new thumbnails from the storage server, and sends tag requests including the storage addresses to the identification server. Then the identification server acquires the thumbnails from the storage server based on the storage addresses.

Or, the storage server may also send a prompt message to the service server after storing a new thumbnail. After receiving the prompt message, the service server acquires a storage address of the new thumbnail from the storage server, and sends a tag request including the storage address to the identification server. Then the identification server acquires the thumbnail from the storage server based on the storage address.

The identification server obtains the image tags by identifying the thumbnail, and sends the image tags to the service server. The service server stores the received image tags.

In one case, the storage server may delete thumbnails that were stored for a long period of time periodically or non-periodically to save storage resources.

In the implementation shown in FIG. 3, the service server stores the addresses of the thumbnails and corresponding tags, and the tags are helpful for subsequent sorting, retrieving, recommendation, or the like for the thumbnails.

The implementations shown in FIG. 1 and FIG. 2 may be used to generate corresponding tags with respect to the image uploaded by the user. The above-described implementation shown in FIG. 3 may be applied to an offline scenario in which, for example, assuming that new thumbnails are continuously uploaded to the storage server, the service server may acquire the storage addresses of the new thumbnails from the storage server, and send tag requests including the storage addresses to the identification server.

For example, the “image” in the embodiments of the present disclosure may be a painting, and the tags of the painting may include a category, a subject, content, or the like of the painting. For example, the category may include oil painting, wash painting, etc., the subject may be a landscape, a person, etc., and the content may include various material objects in the painting, etc. Thus, the implementations shown in FIG. 1 and FIG. 2 can be used to generate corresponding tags with respect to the painting uploaded by the user. The above-described implementation shown in FIG. 3 may be applied to an offline scenario in which, for example, assuming that a museum continuously uploads thumbnails of paintings in batch, the service server may acquire storage addresses of the new thumbnails from the storage server and send tag requests including the storage addresses to the identification server.

By applying the above implementations, in the first aspect, since the image tags are automatically generated by the servers, the dependency on human experiences is reduced. In the second aspect, the servers identify the thumbnails, and compared with the identification of original images, an amount of computation is reduced. In the third aspect, the thumbnails are transmitted among the devices, and compared with the transmission of the original images, the communication resources are saved. And in the fourth aspect, some images involve copyright or privacy issues, while in this scheme, transmitting and processing the thumbnails solves this problem.

Based on the same inventive concept, the embodiments of the present disclosure provide an image tag generation method. Below, an image tag generation method applied to a first device will be described in detail. FIG. 4 is a schematic flowchart illustrating the image tag generation method applied to the first device provided by an embodiment of the present disclosure, which comprises:

S401: receiving a tag request sent by a second device.

In one implementation, the second device is a service server. In one case, the terminal device sends a tag generation instruction to the service server, and the service server sends a tag request to the first device based on the tag generation instruction (referring to the above implementations shown in FIG. 1 and FIG. 2). Or, in another case, the service server may send a tag request to the first device periodically (or after acquiring a storage address of a new thumbnail) (referring to the above implementation shown in FIG. 3).

Or, in another implementation, the second device is a terminal device, and the terminal device directly sends the tag request to the first device.

S402: acquiring a thumbnail corresponding to the tag request.

In one implementation, the tag request may include the thumbnail. Thus S402 comprises: reading the thumbnail included in the tag request (referring to the above implementation shown in FIG. 1).

For example, the terminal device may obtain the image uploaded by the user, and generate a thumbnail of the image. In one case, the terminal device may directly send a tag request including the thumbnail to the first device. In another case, the terminal device may send a tag generation instruction including the thumbnail to the service server, and the service server sends a tag request including the thumbnail to the first device.

In another implementation, the tag request may include a storage address of the thumbnail. Thus S402 comprises: acquiring the thumbnail corresponding to the storage address from a third device.

The third device may be, for example, a storage server. In one case (referring to the above implementation shown in FIG. 2), the terminal device may obtain the image uploaded by the user, generate a thumbnail of the image, send the thumbnail and the image identification to the storage server. The storage server stores the thumbnail and sends the storage address of the thumbnail and the image identification to the service server, so that the service server stores a correspondence relation between the storage address of the thumbnail and the image identification.

The terminal device sends a tag generation instruction to the service server, wherein the tag generation instruction comprises the image identification. The service server searches for the storage address corresponding to the image identification as an address to be processed; the service server sends a tag generation request comprising the address to be processed to the first device; and the first device acquires the thumbnail from the storage server based on the address to be processed.

In another case (referring to the above implementation shown in FIG. 3), the storage server may continuously store new thumbnails. The service server periodically (or after receiving a prompt message) acquires storage addresses of the new thumbnails from the storage server, and sends tag requests including the storage addresses to the first device. Then the first device acquires the thumbnails from the storage server based on the storage addresses.

S403: obtaining image tags by identifying the thumbnail.

For example, a deep learning algorithm may be used for training a base model to obtain a recognition model, and the thumbnail is input to the recognition model to obtain image tags output by the recognition model. For example, the recognition model may be obtained by training the base framework ResNet-SRN (ResNet: Residual Network; SRN: Spatial Regularization Network), and the specific structure and training process of the recognition model are not limited.

S404: sending the image tags to the second device.

As described above, in one case (referring to the above implementations shown in FIG. 1 and FIG. 2), the second device is a service server, the terminal device sends a tag generation instruction to the service server, and the service server sends a tag request to the first device based on the tag generation instruction. In this case, the first device sends the image tags to the service server, and the service server sends the image tags to the terminal device.

As described above, in another case (referring to the above implementation shown in FIG. 3), the second device is a service server, and the service server sends a tag request to the first device periodically (or after acquiring a storage address of a new thumbnail). In this case, the second device returns the image tags to the service server, and the service server stores the received image tags.

As described above, in still another case, the second device is a terminal device, and thus, the first device directly returns the image tags to the terminal device.

With the embodiment of the present disclosure shown in FIG. 4, the second device sends a tag request to the first device; and, the first device acquires a thumbnail corresponding to the tag request, obtains image tags by identifying the thumbnail and sends the image tags to the second device. It follows that, in this scheme, in the first aspect, the first device automatically generates the image tags, which reduces the dependency on human experiences. In the second aspect, the first device identifies the thumbnails, and compared with the identification of original images, an amount of computation is reduced. In the third aspect, the thumbnails are transmitted among the devices, and compared with the transmission of the original images, the communication resources are saved. And in the fourth aspect, some images involve copyright or privacy issues, so in this scheme, transmitting and processing the thumbnails solves this problem.

An image tag generating method applied to a second device will be described in detail below. FIG. 5 is a schematic flowchart illustrating the image tag generating method applied to the second device provided by an embodiment of the present disclosure, which comprises:

S501: sending a tag request to a first device, so that the first device acquires a thumbnail to be identified based on the tag request, and obtains image tags by identifying the thumbnail.

In one implementation (referring to the above implementation shown in FIG. 3), S501 may comprise: acquiring an address of a new thumbnail from a third device periodically, and sending the tag request comprising the address of the new thumbnail to the first device. Alternatively, S501 may comprise: after receiving a prompt message from the third device, acquiring the address of the new thumbnail from the third device, and sending the tag request including the address of the new thumbnail to the first device.

For example, the third device may be a storage server, the second device may be a service server, and the first device may be an identification server. The storage server can continuously store new thumbnails. The service server periodically acquires the storage addresses of the new thumbnails from the storage server, and sends tag requests including the storage addresses to the identification server. Alternatively, the storage server may send a prompt message to the service server after storing the new thumbnails. After receiving the prompt message, the service server acquires the storage addresses of the new thumbnails from the storage server, and then sends the tag request including the storage addresses to the identification server. The identification server acquires the thumbnail from the storage server based on the address.

In another implementation (referring to the above implementations shown in FIG. 1 and FIG. 2), S501 may comprise: receiving a tag generation instruction sent by a terminal device; and sending the tag request to the first device based on the tag generation instruction.

For example, the terminal device sends a tag generation instruction to the service server, and the service server sends the tag request to the identification server based on the tag generation instruction.

In one case (referring to the above implementation shown in FIG. 1), the tag generation instruction may include a thumbnail, so that the second device may read the thumbnail included in the tag generation instruction and send a tag request including the thumbnail to the first device. The first device identifies the thumbnail to obtain image tags.

Or, in another case (referring to the above implementation shown in FIG. 2), the tag generation instruction may include an image identification, so that the second device may read the image identification included in the tag generation instruction as an identification to be searched for, search for a storage address corresponding to the identification to be searched for as an address to be processed, and sending the tag request comprising the address to be processed to the first device. The first device acquires a thumbnail corresponding to the address to be processed from the third device, and identifies the thumbnail to obtain image tags.

The second device may receive the storage address of the thumbnail and the image identification, which are sent by the third device after the third device storing the thumbnail uploaded by the terminal device. In this way, the second device may search for, based on the received storage address of the thumbnail and the image identification, the storage address corresponding to the identification to be searched for as the address to be processed.

For example, the third device may be a storage server. In one case, the terminal device may acquire an image uploaded by the user, generate a thumbnail of the image, send the thumbnail and an image identification to the storage server. The storage server stores the thumbnail, and sends a storage address of the thumbnail and the image identification to the service server. Thus the service server stores a correspondence relation between the storage address of the thumbnail and the image identification.

The terminal device sends a tag generation instruction to the service server, wherein the tag generation instruction comprises an image identification. The service server searches for a storage address corresponding to the image identification as an address to be processed, and sends a tag generation request including the address to be processed to the identification server. And the identification server acquires the thumbnail from the storage server based on the address to be processed.

S502: receiving the image tags returned by the first device.

Continuing the above example, the first device may be an identification server. After acquiring the thumbnail, the identification server obtains image tags by identifying the thumbnail, and sends the image tags to the second device.

In the above implementation, the terminal device sends a tag generation instruction to the service server, and the service server sends a tag request to the identification server based on the tag generation instruction. In this case, after S502, the second device may send the image tags to the terminal device.

With the embodiments shown in the present disclosure, the second device sends a tag request to the first device; and, the first device acquires a thumbnail corresponding to the tag request, obtains image tags by identifying the thumbnail, and sends the image tags to the second device. It follows that, in this scheme, in the first aspect, the first device automatically generates the image tags, which reduces the dependency on human experiences. In the second aspect, the first device identifies the thumbnails, and compared with the identification of original images, an amount of computation is reduced. In the third aspect, the thumbnails are transmitted among the devices, and compared with the transmission of the original images, the communication resources are saved. And in the fourth aspect, some images involve copyright or privacy issues, so in this scheme, transmitting and processing the thumbnails solves this problem.

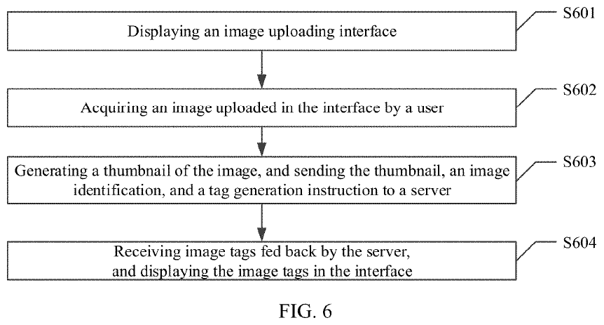

FIG. 6 is a schematic flowchart illustrating an image tag generation method applied to a terminal device provided by an embodiment of the present disclosure, which comprises:

S601: displaying an image uploading interface.

For example, the terminal device may have a display screen in which an image uploading interface is presented to enable a user to upload an image to the terminal device.

S602: acquiring an image uploaded in the interface by the user.

For example, the image uploaded by the user may be an image stored locally in the terminal device, or an image acquired by a camera of the terminal device, and specific image source, image format, and image content are not limited. In one case, the image may be a painting, a painted-screen Application (APP) or a painted-screen plug-in may be configured in the terminal device, and the user may upload some paintings through the painted-screen APP or the painted-screen plug-in.

S603: generating a thumbnail of the image, and sending the thumbnail, an image identification, and a tag generation instruction to a server.

For example, the image may be compressed to obtain a thumbnail. The data amount of the thumbnail is smaller than that of the image. A specific manner of generating the thumbnail is not limited. The image identification may be an image name, a serial number, or the like, and it is not limited.

S604: receiving image tags fed back by the server, and displaying the image tags in the interface.

For example, the server may be a device, for example, it may be the second device (service server) in the above implementation of FIG. 1.

Alternatively, the server may also be a server cluster, for example, in the above implementation of FIG. 2, the server may comprise: a first device, a second device, and a third device.

In this case, S603 may comprise: sending the thumbnail and the image identification to a third device so that the third device, after storing the thumbnail, sends the storage address of the thumbnail and the image identification to a second device; sending a tag generation instruction including the image identification to the second device so as to cause the second device to search for a storage address corresponding to the image identification as an address to be processed; and, sending a tag request including the address to be processed to the first device to cause the first device to acquire the thumbnail from the third device based on the address to be processed and obtain image tags by identifying the thumbnail.

S604 may comprise: receiving the image tags returned by the second device, wherein the image tags are sent to the second device by the first device.

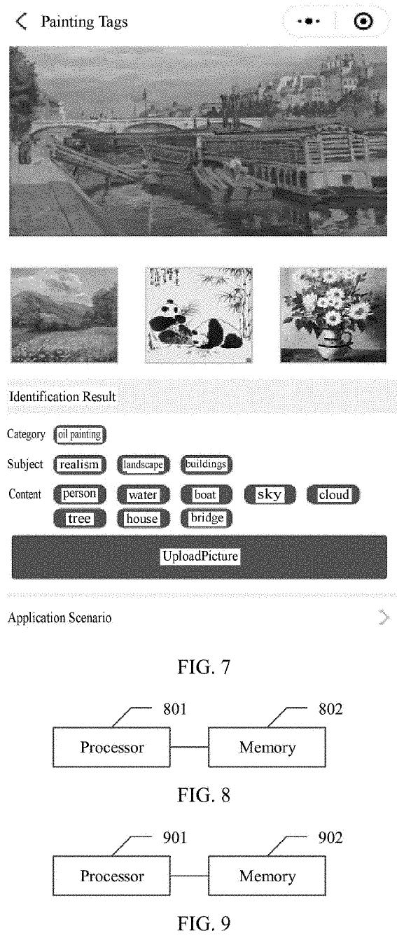

For example, the application scenario may be as shown in FIG. 7, where FIG. 7 may be understood as a display interface of the terminal device. The largest picture at the top of FIG. 7 may be understood as a painting that the user currently needs to upload. Three small pictures in the middle of FIG. 7 may be understood as paintings that the user has uploaded, or may be paintings that the user needs to upload next. And the recognition result at the bottom of FIG. 7 is the image tags for “the painting that the user currently needs to upload”, fed back by the server, where the image tags comprise a category, a subject, and a content of the painting.

In some cases, the user may delete or edit the image tags displayed in S604, or may manually add other image tags, which can improve the user's satisfaction.

In one embodiment, after S604, the method may further comprise: after receiving a deleting instruction sent by the user, determining a tag to be deleted in the displayed image tags based on the deleting instruction, and deleting the tag to be deleted from the displayed image tags;

or, after receiving an editing instruction sent by the user, determining a tag to be edited in the displayed image tags based on the editing instruction, editing the tag to be edited based on editing content input by the user, and displaying the edited tag in the displayed image tags;

or, after receiving a tag adding instruction sent by the user, generating a tag to be added based on tag content input by the user, and displaying the tag to be added in the displayed image tags.

In one implementation, after an uploading instruction of a user is received, the images and the tags displayed in the interface are uploaded.

If the user does not operate the image tags displayed by the terminal device, the images and the tags displayed in the interface are uploaded after receiving the uploading instruction, and in this case, the tags displayed in the interface are the image tags fed back by the server. If the user operates (deletes, edits, and/or adds) the image tags displayed by the terminal device, the images and the tags displayed in the interface are uploaded after receiving the uploading instruction, and in this case, the tags displayed in the interface are the image tags operated by the user.

Referring to FIG. 7, a user may click on an “upload picture” button in the interface to upload a picture and its corresponding tags. In one case, the painting and its corresponding tags can be uploaded to the storage server and the service server, and specific uploading manner and uploading address are not limited.

In some cases, a user needs to upload an image through a mobile phone, a tablet computer, and other terminal devices to share content or achieve the social purpose. In the process of uploading an image, the user often needs to add image tags, for example, a category of the image, such as a travel photograph, a life photograph, a certificate photograph, etc., and for another example, a subject of the image, such as a landscape, a person, etc. In some related schemes, the image and its tags are uploaded generally after the user manually filling in the image tags. In this way, the user is required to manually recognize the category, subject, and the like of the image, and the user is also required to call up an input method and manually click the keyboard of the input method to enter the tags such as the category, subject, and the like of the image, which is troublesome for the user.

By applying the embodiment shown in FIG. 6 of the present disclosure, in the process of uploading an image in the terminal device, the terminal device may obtain the image tags through the server, so that the user does not need to manually fill in the image tags, thereby simplifying the user operation.

The embodiments of the present disclosure further provides a server, as shown in FIG. 8, comprising a memory 802, a processor 801, and a computer program stored on the memory 802 and executable on the processor 801, the processor 801, when executing the program, implementing any of the image tag generation methods applied to the first device, or implementing any of the image tag generation methods applied to the second device.

The embodiments of the present disclosure further provide a terminal device, as shown in FIG. 9, comprising a memory 902, a processor 901, and a computer program stored on the memory 902 and executable on the processor 901, the processor 901, when executing the program, implementing any of the image tag generation methods applied to the terminal device.

The memory 802, 902 may include, but is not limited to, a disk drive, an optical storage device, a solid state memory device, a floppy disk, a flexible disk, a hard disk, a magnetic tape, or any other magnetic medium, a compact disc, or any other optical medium, a ROM (read only memory), a RAM (random access memory), a cache memory, and/or any other memory chip or cartridge, and/or any other medium from which the processor may read data, instructions, and/or code. The processors 801, 901 may be any type of processor and may include, but are not limited to, one or more general purpose processors and/or one or more special purpose processors (such as special purpose processing chips).

The embodiments of the present disclosure further provide a non-transitory computer-readable storage medium storing computer-readable instructions that, when executed by one or more processors, cause the one or more processors to implement any of the above-described image tag generation methods.

All the embodiments in the present specification are described in a related manner, and the same and similar parts among the embodiments may refer to each other, and each embodiment focuses on differences from other embodiments. In particular, for the server embodiment shown in FIG. 8, the terminal device embodiment shown in FIG. 9, and the non-transitory computer readable storage medium embodiment, since they are substantially similar to the image tag generation method embodiments shown in FIGS. 1 to 7, they are described relatively simple, and their relevant points can refer to the partial description of the image tag generation method embodiments shown in FIGS. 1 to 7.

Those of ordinary skill in the art will understand that, the discussion of any embodiment above is exemplary only, and is not intended to imply that the scope of the present disclosure (including the claims) is limited to these examples; under the idea of the present disclosure, technical features of or between the above different embodiments may be also combined, steps may be executed in any order, and there are many other variations of the different aspects of the present disclosure as described above, which are not provided in detail for the sake of brevity.

In addition, well known power/ground connections to Integrated Circuit (IC) chips and other components may or may not be shown in the provided drawings for simplicity of illustration and discussion, and so as not to obscure the present disclosure. Further, devices may be shown in a block diagram form in order to avoid obscuring the present disclosure, and also in view of the fact that details with respect to implementations of such block diagram devices are highly dependent upon the platform on which the present disclosure is to be implemented (i.e., these details should be well within purview of one skilled in the art). Where specific details (e.g., circuits) are set forth in order to describe exemplary embodiments of the present disclosure, it should be apparent to one skilled in the art that the present disclosure can be practiced without, or with variation of, these specific details. Accordingly, the description is to be regarded as illustrative instead of restrictive.

While the present disclosure has been described in conjunction with specific embodiments thereof, many alternatives, modifications, and variations thereof will be apparent to those skilled in the art in light of the foregoing description. For example, other memory architectures (e.g., dynamic RAM (DRAM)) may be used with the discussed embodiments.

The embodiments of the present disclosure are intended to embrace all such alternatives, modifications and variations that fall within the broad scope of the appended claims. Therefore, any omissions, modifications, equivalents, improvements, and the like that may be made without departing from the spirit or scope of the present disclosure are intended to be included within the scope of the present disclosure.

What is claimed is:

1. An image tag generation method applied to a first device, comprising:
receiving a tag request sent by a second device;
acquiring a thumbnail corresponding to the tag request;
obtaining image tags by identifying the thumbnail; and
sending the image tags to the second device.

2. The method according to claim 1, wherein the acquiring a thumbnail corresponding to the tag request comprises: reading the thumbnail included in the tag request.

3. The method according to claim 1, wherein the tag request includes a storage address of the thumbnail, and, the acquiring a thumbnail corresponding to the tag request comprises: acquiring the thumbnail corresponding to the storage address from a third device.

4. The method according to claim 1, wherein the second device receives a tag generation instruction sent by a terminal device, and the second device sends the tag request to the first device based on the tag generation instruction.

5. The method according to claim 4, wherein that the second device sends the tag request to the first device based on the tag generation instruction comprises:
reading the thumbnail included in the tag generation instruction; and
sending the tag request including the thumbnail to the first device.

6. The method according to claim 4, wherein that the second device sends the tag request to the first device based on the tag generation instruction comprises:
reading an image identification included in the tag generation instruction as an identification to be searched for;
searching for a storage address corresponding to the identification to be searched for as an address to be processed; and
sending the tag request including the address to be processed to the first device.

7. The method according to claim 6, wherein the second device receives the storage address of the thumbnail and the image identification, which are sent by a third device after the third device storing the thumbnail uploaded by the terminal device; and
the searching for a storage address corresponding to the identification to be searched for as an address to be processed comprises: searching for the storage address corresponding to the identification to be searched for as the address to be processed based on the received storage address of the thumbnail and image identification.

8. The method according to claim 1, wherein the second device acquires an image uploaded by a user, generates a thumbnail of the image, and sends the tag request including the thumbnail to the first device.

9. The method according to claim 1, wherein the second device acquires an image uploaded by the user, generates the thumbnail of the image, sends the thumbnail and an image identification to a third device for storage and receives a storage address of the thumbnail corresponding to the image identification from the third device, and sends the tag request including the storage address to the first device.

10. The method according to claim 1, wherein the obtaining image tags by identifying the thumbnail is accomplished by using a recognition model obtained by training a base model with use of a deep learning algorithm.

11. The method according to claim 1, wherein the image tags comprise tags indicating at least one of a category, a subject, and content of the thumbnail.

12. An image tag generation method applied to a second device, comprising:
sending a tag request to a first device, so that the first device acquires a thumbnail to be identified based on the tag request, and obtains image tags by identifying the thumbnail; and
receiving the image tags returned by the first device.

13. The method according to claim 12, wherein the sending a tag request to a first device comprises:
acquiring an address of a new thumbnail from a third device periodically, and sending the tag request including the address of the new thumbnail to the first device;
or, after receiving a prompt message from a third device, acquiring an address of a new thumbnail from the third device, and sending the tag request including the address of the new thumbnail to the first device.

14. An image tag generation method applied to a terminal device, comprising:
displaying an image uploading interface;
acquiring an image uploaded in the interface by a user;
generating a thumbnail of the image, and sending the thumbnail, an image identification, and a tag generation instruction to a server; and
receiving image tags fed back by the server, and displaying the image tags in the interface.

15. The method according to claim 14, further comprising the following steps after displaying the image tags in the interface:
after receiving a deleting instruction sent by the user, determining a tag to be deleted in the displayed image tags based on the deleting instruction, and deleting the tag to be deleted from the displayed image tags;
or, after receiving an editing instruction sent by the user, determining a tag to be edited in the displayed image tags based on the editing instruction, editing the tag to be edited based on editing content input by the user, and displaying the edited tag in the displayed image tags;
or, after receiving a tag adding instruction sent by the user, generating a tag to be added based on tag content input by the user, and displaying the label to be added in the displayed image tags.

16. The method according to claim 14, wherein the method further comprises:
after receiving an uploading instruction from the user, uploading the image and the image tags displayed in the interface.

17. The method according to claim 14, wherein the server comprises: a first device, a second device, and a third device;
the sending the thumbnail, an image identification and a tag generation instruction to a server comprises:
sending the thumbnail and the image identification to the third device so that the third device, after storing the thumbnail, sends a storage address of the thumbnail and the image identification to the second device, and
sending the tag generation instruction including the image identification to the second device, so that the second device searches for the storage address corresponding to the image identification as an address to be processed, and sends a tag request including the address to be processed to the first device so as to cause the first device to acquire the thumbnail from the third device based on the address to be processed and obtain the image tags by identifying the thumbnail; and
the receiving image tags fed back by the server comprises:
receiving the image tags returned by the second device, wherein the image tags are sent to the second device by the first device.

18. A server comprising a memory, a processor, and a computer program stored on the memory and executable on the processor, wherein the processor, when executing the program, implements the method according to claim 1.

19. A server comprising a memory, a processor, and a computer program stored on the memory and executable on the processor, wherein the processor, when executing the program, implements the method according to claim 12.

20. A terminal device comprising a memory, a processor, and a computer program stored on the memory and executable on the processor, wherein the processor, when executing the program, implements the method according to claim 14.
